(19) United States
(12) Patent Application Publication
(10) Pub. No.: US 2010/0048374 A1
(43) Pub. Date: Feb. 25, 2010

(54) System and Method for Fabricating Ceramic Substrates

(76) Inventors: James Jenq Liu, Mason, OH (US); Bilal Zuberi, Cambridge, MA (US); William M. Carty, Alfred Station, NY (US); Rachel A. Dahl, Yuba City, CA (US); Jerry C. Weinstein, Malta, NY (US); Sunilkumar C. Pillai, Oakdale, PA (US); Timothy Gordon, Pittsburgh, PA (US); James Marshall, Latrobe, PA (US)

Correspondence Address: GEO2 TECHNOLOGIES, 12-R CABOT ROAD, WOBURN, MA, 01801, US

(21) Appl. No.: 12/473,562

(22) Filed: May 28, 2009

Related U.S. Application Data
(63) Continuation-in-part of application No. 11/322,777, filed on Dec. 30, 2005.
(60) Provisional application No. 60/737,237, filed on Nov. 16, 2005.
(60) Provisional application No. 61/057,169, filed on May 29, 2008.

(51) Int. Cl. C03C 10/14

(52) U.S. Cl. 501/4

(57) ABSTRACT

This invention provides a system and method for establishing proper quantities of components in the initial mixture to be used in the fabrication of a porous ceramic substrate. The components typically consist of a solvent, a bulk fiber such as mullite, an organic binder for use in extrusion of the green substrate, a glass/clay bonding phase that bonds the fibers upon high-temperature curing and a pore former that defines gaps between the particles and is vaporized out of the substrate during curing. By identifying the controllable factors related to each of the components, and adjusting the factors to vary the resulting strength and porosity of the cured substrate, an optimized strength and porosity performance can be achieved. The controlling factors for each component include its relative weight percent in the mixture. The fiber component is also controlled via fiber diameter, diameter uniformity, and fiber length-to-diameter aspect ratio. Likewise, pore former is also controlled by particle size and shape and particle density. The bonding phase may also be controlled based upon its contribution to the viscosity at sintering temperature.

### CROSS-REFERENCE TO RELATED APPLICATIONS

This application is a continuation-in-part to U.S. patent application Ser. No. 11/322,777 entitled “Process for Extruding a Porous Substrate” filed Dec. 30, 2005, which claims priority to U.S. provisional patent application Ser. No. 60/737,237 entitled “System for Extruding a Porous Substrate” filed Nov. 16, 2005. This application also claims priority to U.S. provisional patent application No. 61/057,169, entitled “System and Method for Fabricating Ceramic Substrates” filed May 29, 2008. The entire contents of U.S. patent application Ser. No. 11/322,777, provisional patent applications Ser. No. 60/737,237 and provisional patent application Ser. No. 61/057,169 are each incorporated herein by reference.

### FIELD OF THE INVENTION

This invention relates to systems and methods for fabricating ceramic substrates useful for insulation, filtration and/or high-temperature chemical reaction processing, such as a catalytic host, and more particularly to systems and methods for fabricating fiber-based ceramic substrates within predetermined parameters.

### BACKGROUND OF THE INVENTION

Porous ceramic substrates are commonly used for high-temperature processes, such as exhaust filtration, insulation, and as a catalytic host in chemical reactors. Porous ceramic substrates provide high operating temperature capabilities, with mechanical stability and chemical inertness. For example, porous ceramic substrate materials are useful for high temperature insulation, filtration, and for hosting catalytic reactions. The materials, in any of a variety of forms, can be used in high temperature applications as catalytic converters, NOx adsorbers, DeNox filters, multi-function filters, molten metal transport mechanisms and filters, regenerator cores, chemical processes, fixed-bed reactors, hydrodesulfurization, hydrocracking or hydrotreating, and engine exhaust filtration.

Improvements in porosity, and effective surface area can be provided by fibrous microstructures to provide excellent strength at low mass, to survive wide and sudden temperature excursions without exhibiting thermal shock or mechanical degradation. Ceramic fibers are typically used to fabricate high temperature rigid insulating panels, such as vacuum cast boards, used for lining combustion chambers and high temperature environments that require impact resistance. Casting processes can also be used to form rigid structures composed of ceramic fibers such as kiln furniture and setter tiles.

These rigid structures can be formed that maintain structural integrity at extremely high temperatures in order to meet the processing requirements of the intended application. The ceramic fiber forming the basis for the substrate material composition can be fabricated from a number of materials in a variety of processes.

Generally, the goal of a substrate fabrication process is to produce a substrate with (a) the highest possible strength, as exhibited by the modulus or rupture (MOR), or “crush strength”, and (b) a high, uniform porosity, necessary for good filtration with minimal back-pressure over the longest duration of use without filter replacement or regeneration. Because more pores tend reduce the number of sintered bonds in the fiber lattice, there is an unavoidable tradeoff between porosity and strength. Likewise, thermal shock resistance may be affected by porosity, strength and the material composition. However, despite the need to compromise between strength and porosity (among other performance factors) in fabricating a porous ceramic fiber substrate, it may still be possible to carefully select components, and their ratios in the initial mixture, to achieve the best combination of strength and porosity for a given substrate.

The selection of the proper combination of components for the initial mixture has heretofore largely involved the design of experiments, using differing amounts and types components, with more or less solvent. A system for optimizing the mixture to achieve a desired (or optimized) strength and porosity is highly desirable. In this manner, the designer can better predict the performance characteristics of the substrate without significant trial-and-error experimentation.

### BRIEF SUMMARY OF THE INVENTION

This invention overcomes the disadvantages of the prior art by providing a system and method for establishing proper quantities of components in the initial mixture to be used in the fabrication of a porous ceramic substrate. The components typically consist of a solvent, a bulk fiber (“fiber” being generally defined as a particle with an elongate structure, having a length-to-diameter aspect ratio of greater than one) such as mullite, an organic binder for use in extrusion of the green substrate, a glass/clay bonding phase that bonds the fibers upon high-temperature curing and a pore former that defines gaps between the particles and is vaporized out of the substrate during curing (which causes sintering of the substrate fibers into a solid lattice). By identifying the controllable factors related to each of the components, and adjusting the factors to vary the resulting strength and porosity of the sintered substrate, an optimized strength and porosity performance can be achieved. The controlling factors for each component include its relative weight percent in the mixture. The fiber component is also controlled via fiber diameter, diameter distribution, and fiber aspect ratio. Likewise, properties influence by pore former can also be controlled by particle size particle size distribution, and shape and particle density. The bonding phase may also be controlled based upon its contribution to mixture viscosity at curing/sintering temperatures, melting point and reactivity.

According to an illustrative embodiment a system and method for fabricating a ceramic substrate includes providing a plurality of components to an initial mixture in solution with a fluid solvent including at least a first component and a second component. At least one controllable factor respectively associated with each of the components is identified, and a curve of strength and porosity in a cured/sintered substrate achieved by varying each controllable factor is determined for each factor. The system and method thereby allows the designer to vary the controllable factor of the first component based upon the respective curve for the controllable factor of the first component. Then, to compensate for a change in strength and porosity by varying the controllable factor of the first component, the designer varies the controllable factor of the second component based upon the curve for the controllable factor of the second component. In this manner a change of each component that results in a new mapping along the porosity/strength curve is compensated by mapping a corresponding variation of the component's controlling factor back up the curve. In an illustrative embodiment, an optimized mixture can include between approximately 5 and 45 percent pore former and between 2 and 33 percent bonding phase. More particularly, a porous ceramic substrate formed from an initial mixture in solution includes (a) a ceramic fiber, (b) an organic binder between 2 and 20 percent, (c) a pore former that comprises between approximately 4 to 45 percent weight of the initial mixture on a dry weight basis, and (d) an inorganic bonding phase that comprises between approximately 2 and 33 percent weight of the initial mixture on a dry weight basis. The ceramic fiber can comprises bulk mullite fiber between approximately 45 and 55 percent weight of the initial mixture on a dry weight basis and the inorganic bonding phase can comprise comprises a combination of bentonite and glass.

In further embodiments, a third component can be varied in combination with the first and second components by mapping the curve of the controllable factor of the third component to achieve the desired porosity and strength. In a particular embodiment the mixture weight percentage of pore former is reduced to approximately 20 percent dry weight basis. This results in a decrease in porosity of the cured/sintered substrate below the desired 60 (or more) percent, and increases strength more than required. As a reduction in the amount of inorganic bonding phase tends to increase porosity, and decrease strength, this adjustment to the bonding phase component allows porosity to be increased following the reduction in pore former without significant reduction in the strength of the substrate.

### BRIEF DESCRIPTION OF THE SEVERAL VIEWS OF THE DRAWING

The invention description below refers to the accompanying drawings, of which:

FIG. 1 is a flow diagram of a generalized substrate fabrication procedure and the mixture components employed therein;

FIG. 2 is a flow diagram of the curing step according to the procedure of FIG. 1

FIG. 3 is a graph showing the relationship between mixture weight percentage (quantity) of pore former in the substrate initial mixture and the observed effect on substrate strength and porosity;

FIG. 4 is a graph having series of curves representing varied quantities of pore former, each showing the relationship between quantity of bonding phase components in the substrate initial mixture and the observed effect on substrate strength and porosity;

FIG. 5 is a graph showing the relationship between uniformity/distribution of fiber diameter in the substrate initial mixture and the observed effect on substrate porosity;

FIG. 6 is a graph showing a series of curves representing varied pore former particle sizes, each showing the relationship between strength (modulus of rupture) and porosity;

FIG. 7 is a diagram showing the various components in the initial mixture, and the variable characteristics associated with each component, which by varying, affect the strength and porosity of the resulting substrate;

FIG. 8 is a graph showing curves which represent various exemplary distributions of fiber particle diameters, in connection with the fiber component of FIG. 7;

FIG. 9 is a graph of substrate strength versus porosity for each of the curves shown in FIG. 8, in connection with the fiber component of FIG. 7;

FIG. 10 is a graph of various average fiber diameter size levels for use in the initial mixture, in connection with the fiber component of FIG. 7;

FIG. 11 is a graph of substrate strength versus porosity for each curves of FIG. 10, in connection with the fiber component of FIG. 7;

FIG. 12 is a graph of substrate strength and porosity versus the mixture weight-percentage of fiber, in connection with the fiber component of FIG. 7;

FIG. 13 is a graph of substrate strength and porosity versus the mixture weight-percentage of pore former, in connection with the pore former component of FIG. 7;

FIG. 14 is a graph of substrate strength and porosity versus the pore former particle size and shape, in connection with the fiber component of FIG. 7;

FIG. 15 is a graph of pore former relative quantity in the mixture versus the pore former particle density, in connection with the fiber component of FIG. 7;

FIG. 16A is a graph of substrate strength and porosity versus the particle size and shape, in connection with the bonding phase component of FIG. 7;

FIG. 16B is a graph of substrate strength and porosity versus the mixture bonding phase relative quantity, in connection with the bonding phase component of FIG. 7;

FIG. 17A is a graph of pore size distribution as a function of particle size of the bonding phase component of FIG. 7;

FIG. 17B is a graph of bonding phase relative quantity in the mixture versus the mixture viscosity, in connection with the bonding phase component of FIG. 7;

FIG. 18 is a graph of substrate strength and porosity versus the mixture relative quantity of organic binder (HPMC in this example), in connection with the organic binder component of FIG. 7;

FIG. 19 is a version of the graph of FIG. 3 showing the relationship between quantity of pore former in the substrate initial mixture and the observed effect on substrate strength and porosity, illustrating the effect on porosity due to the selection of a reduced (20 percent) weight percentage of pore former in the mixture;

FIG. 20 is a version of the graph of FIG. 16 showing substrate strength and porosity versus the mixture weight percentage of bonding phase, illustrating an adjustment in the mixture weight percentage of bonding phase to compensate for the reduction in pore former to the mixture in accordance with FIG. 19;

FIG. 21 is a three-dimensional graph showing the relationship in the initial mixture between cured/sintered substrate strength, mixture weight percentage of bonding phase (glass/bentonite) and mixture weight percentage of pore former (carbon); and

FIG. 22 is a three-dimensional graph showing the relationship in the initial mixture between cured or sintered substrate strength, mixture weight percentage of organic binder (HPMC) and mixture weight percentage of pore former (carbon).

### DETAILED DESCRIPTION OF THE INVENTION

### A. Overview of Substrate Fabrication

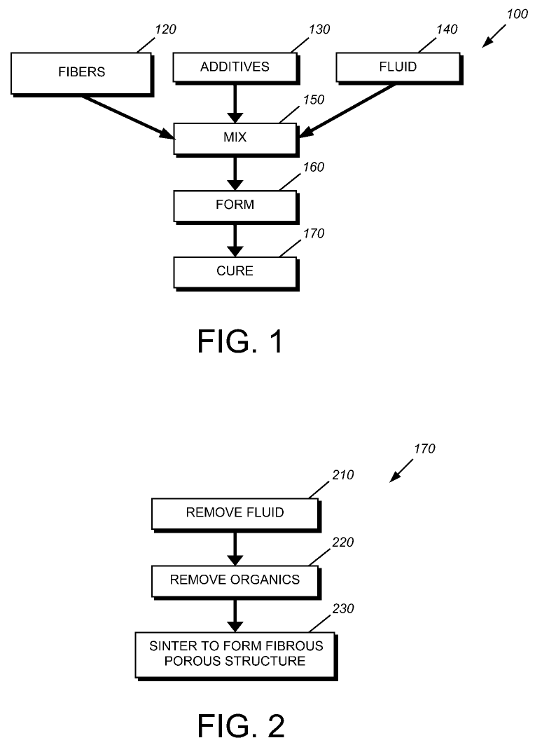

By way of further background, and referring to FIG. 1, a procedure 100 for fabricating a fiber-based substrate according to the present invention is shown. Similar fabrication processes are disclosed in commonly-assigned patent applications, including U.S. patent Ser. No. 11/831,398 entitled “A fiber based ceramic substrate and method of fabricating the same,” and U.S. patent Ser. No. 11/323,429, entitled “An extruded porous substrate and products using the same,” both of which are incorporated herein by reference. Generally, fibers 120, with additives 130 and a solvent fluid (typically water) 140, are mixed 150 into a plastic batch that is formed into a green substrate 160 and fired/cured 170. Note that various embodiments of the substrate can be fabricated to form fiber-based substrates having alternative compositions using any number of different fiber compositions, additives, and solvents. In an exemplary embodiment, mullite fiber can be provided as fibers 120 and the additives 130 form a fibrous structure of mullite bonded with a chemically stable compound.

Mullite fiber, when provided as the fiber 120 in the exemplary embodiment, is commonly used as a refractory material, that has high temperature stability while chemically inert. Mullite fiber is typically in a polycrystalline form that is produced in a fiber form through a sol-gel or melt-spun processes. Mullite is the mineralogical name given to the only chemically stable intermediate phase in the SiO₂—Al₂O₃ system. Mullite is commonly denoted as 3Al₂O₃.2SiO₂ (i.e., 60 mol % Al₂O₃ and 40 mol % SiO₂). However, this is misleading since mullite is actually a solid solution with the equilibrium composition limits of between about 60 and 63 mol % alumina below 1600° C. Mullite is a desirable phase of aluminosilicate materials due to its exceptional high temperature properties. The material exhibits high resistance to thermal shock and thermal stress distribution arising from its low coefficient of thermal expansions, good strength and interlocking grain structure. Mullite is also characterized by relatively low thermal conductivity and high wear resistance. These properties do not suffer much at elevated temperatures, allowing the substrate structure to remain useable at high temperatures.

In an alternate exemplary embodiment, aluminosilicate fiber can be provided. Aluminosilicate fiber 120 is commonly used as a refractory material, as it is available at low cost due to the abundance of raw materials used, and the ability to fiberize the material using a melt fiberization process, such as melt-spun or blown. The aluminosilicate fibers 120 are in an amorphous or vitreous state when initially provided in fiber form. When aluminosilicate material having an alumina (Al₂O₃) content between about 15% and about 72% (by volume or mass) is exposed to temperatures up to about 1600° C., the amorphous composition will form polycrystalline mullite and amorphous or crystalline silica (SiO₂). The process of de-vitrification and crystallization begins at temperatures as low as 900° C. but the rate of reaction/conversion increases with temperature.

The inorganic binder of the additives 130 can react with the fibers 120 and/or form bonds between adjoining fibers 120 to form a rigid and porous microstructure. Additives 130 including inorganic binders can include glass precursors or compositions that promote the formation of bonds between fibers 120. The additives 130 can, for example, contribute to change the phase formation of the silica from the fibers during the cure step 170. By reacting with free silica in the fiber 120 and/or the with the additives 130, a stable glass compound can be formed. Further, the composition of the additives 130 can react to form a ternary or other complex system with alumina and silica or other compositions from the fibers 120. For example, the additives 130 comprising Calcium Oxide (CaO), commonly known as lime, can react with alumina and silica during the cure step 170 to form mullite with a stable glass bond (the bonding phase). Another example reacts the additives 130 with the silica in the fibers to form an amorphous glass compound devoid of an ordered crystalline structure, so that without a seed for crystallization, the formation of crystal silica can be inhibited.

In exemplary embodiments of the present invention, veegum clay comprising magnesium alumina silicate, bentonite clay comprising calcium magnesium alumina silicate, cerium, titanium oxide, and a glass frit, among others, can be included as an inorganic bonding phase in the additive 130. For example, Ferro Frit 3851 used in glaze coatings of pottery contains alumina (26.8% by weight), silica (48.9%), magnesia (23.8%), and calcium oxide (0.5%), that can be used as an inorganic binder, though other materials having different compositions can also be used. Typically, the inorganic binder will be provided in powder or particle form, though alternatively, the inorganic binder can also be at least partially provided in a fiber form.

Referring further to FIG. 1, the fibers 120 used in the procedure 100 can be polycrystalline mullite fiber, or vitreous aluminosilicate fibers that are typically used as refractory materials, such as bulk or chopped fibers, or a combination thereof. In an exemplary embodiment, FIBERFRAX HS-95C from Unifrax, Niagara Falls, N.Y. can be used. In alternate embodiments, FIBERMAX polycrystalline mullite fiber from Unifrax, Niagara Falls, N.Y. can be used. Biosoluble compositions, such as ISOFRAX fiber from Unifrax, Niagara Falls, N.Y. can used in still further embodiments. Fibers 120 can include ceramic fibers, glass fibers, metal fibers, intermetallic fibers, oxide fibers, carbide fibers, nitride fibers, and combinations thereof.

The additives 130, as previously discussed, comprise inorganic binder materials (bonding phase) that can promote the formation of bonds during the subsequent curing/firing operation 170. For example, clay additives, such as bentonite, veegum, and others, and/or colloidal silica, colloidal alumina, and others, and/or frits or glass precursors, in appropriate quantities, can react to form glass and/or glass-ceramic materials that provide fiber-to-fiber bonds between adjoining fibers during the sintering step 170. Additionally, the additives can contain organic binders, extrusion or forming aids, rheology modifiers and processing aids and plasticizers that may be useful during the subsequent forming step 160. For example, organic binders that can be included as additives 130 include methylcellulose, hydroxypropyl methylcellulose (HPMC), ethylcellulose and combinations thereof.

Pore formers can be included as additives 130 to enhance the porosity of the final structure. Pore formers are non-reactive materials that occupy volume in the plastic mixture during the mixing step 150 and the subsequent forming step 160, though readily removed during the curing/firing step 170 via pyrolysis or by thermal degradation or volatilization. For example, micro-wax emulsions, phenolic resin particles, flour, starch, or, in the illustrative embodiment, carbon particles can be included as an additive 130 that will burn out (sublime/vaporize) during the subsequent curing step 170. The pore former can also impart fiber alignment or orientation characteristics during the forming step 160, depending upon the distribution of particle shape or aspect ratio. Inorganic binders can also act as a pore former when they are provided in a low density form, such as hollow spheres or aerogels.

Other processing aids, such as plasticizers, or rheology modifiers can be added as additives 130 to improve or optimize the formability of the plastic mixture during the subsequent forming step 160. The pore former materials or materials that react with the fiber can also act as processing aids, by enhancing the plasticity or lubricity of the plastic mixture. For example, carbon pore formers provide lubrication when the plastic mixture is extruded into various forms, and clay-based inorganic additives, such as veegum or bentonite, provide plasticity of the mixture.

The fluid 140 is added as needed to attain a desired rheology of the plastic mixture suitable for the forming step 160. Water is typically used, though fluid solvents of various types can be utilized, along with liquids associated with additives, such as bonding agents or other additives that may be introduced into the mixture as a colloidal or sol suspension in a liquid. Rheological measurements can be made during the mixing step 150 to evaluate the rheology of the mixture compared with a desired rheology for the forming step 160. Excess fluid may not be desirable in that excessive shrinking may occur during the curing step 170 that may induce the formation of cracks in the substrate.

The fibers 120, additives 130, and fluid 140 are mixed at the mixing step 150 to evenly distribute the materials into a homogeneous mass with a desired rheology for the forming step 160. This mixing may include dry mixing, wet mixing, shear mixing, and kneading, which may be necessary to evenly distribute the material into a homogeneous mass while imparting requisite shear forces to break up and distribute and/or de-agglomerate the fibers, particles and fluid. The amount of mixing, shearing, and kneading, and duration of such mixing processes depends on the fiber characteristics (length, diameter, etc.), the type and quantity of additives 130, and the type and amount of fluid 140, in order to obtain a uniform and consistent distribution of the materials within the mixture, with the desired rheological properties that are desired for the forming process 160.

The forming process can include any type of processing that forms the plastic mixture of the mixing step 150 into the desired form of the green substrate. As non-limiting examples, the forming step 160 can include extrusion, vacuum casting, and casting. The forming step 160 for the fiber-based ceramic substrate of the present invention is similar to the forming steps for powder-based ceramic substrate materials. In extrusion of a honeycomb substrate for use in an exemplary vehicle exhaust, the plastic mixture containing a suitable plasticizing aid, such as HPMC, and having a suitable rheology, is forced under pressure through a honeycomb die to form a generally continuous honeycomb block that is cut to a desired length. In the example of a vehicle exhaust filter, a honeycomb die determines the size and geometry of the honeycomb channels, and can be rectangular, triangular, hexagonal, or other polygonal shaped channels, depending on the design of the extrusion die. Additionally, alternative designs, such as asymmetric channels, with wider inlet channels can also be implemented using appropriate extrusion dies. The extrusion system used for the forming step 160 can be of the type typically used to extrude powder-based ceramic materials, for example, a piston extruder or screw-type extruder. One skilled in the art will appreciate that certain aspects of the mixing step 150 can be performed in a screw extruder during the forming step 160. Vacuum cast processes and other casting methods can similarly form the plastic mixture into the green substrate with the rheology and plasticity of the plastic mixture having the properties sufficient to form the substrate and yet retain its shape for subsequent processing. Generally, the forming step 160 produces a green substrate, which has sufficient green strength to hold its shape and relative fiber arrangement during the subsequent curing step 170.

Forming the plastic mixture of fibers 120, additives 130 and fluid 140 into a green substrate, and subsequently curing the substrate, as herein described below, creates a unique microstructure of intertangled fibers in a ceramic substrate. After the subsequent curing step 170, when certain portions of the additives 130 and fluid 140 are removed while still retaining the relative fiber spacing throughout the substrate, the resulting structure can become quite porous. The porosity of the substrate, as a result of the movement and alignment of the fibers during forming, exhibits a unique microstructure having a distribution of pores within the substrate creating an open network of pores resulting from the spacing between fibers. Additionally, while the surface of the substrate can be viewed as more akin to a two-dimensional mat of bonded, interlocked and interconnected fibers, distinguished by the internal regions of the substrate, which is a three-dimensional structure of bonded interlocked and interconnected fibers, the surface of the channel walls is not entirely planar. Fiber ends have a tendency to protrude out at an angle from the surface. These protrusions are particularly useful when the substrate is used as a filter, such as a diesel particulate filter, since the protrusion can act as nucleation, coagulation or trapping sites for soot, leading to efficient and uniform soot “cake” formation. The distribution of these sites over the surface of the channel walls ensures that a uniform accumulation of particulates can accumulate, which acts to improve trapping efficiency, more uniform deposition and regeneration of the soot on the filter.

The alignment of fibers, pore size, pore distribution, nucleation, coagulation, and trapping site distribution, and pore characteristics between wall surface and internal regions can be controlled by altering parameters of the forming step 160. For example, the rheology of the mixture, diameter and aspect ratio distributions of the fibers, characteristics of the additives, forming pressure and speed can be varied to attain desired characteristics in the resulting structure of the substrate.

Referring briefly to FIG. 2, the curing step 170 is described in further detail. In general, the substrate is subjected to increasingly higher temperatures. The curing step 170 can be performed as the sequence of three phases: (a) a fluid-removal step 210, (b) an organic-removal step 220; and (c) a sintering step 230. In the first phase, fluid removal 210, the green substrate is dried by removing the fluid using relatively low temperature heat with or without forced convection to gradually remove the fluid. Various methods of applying relatively low temperature heat into the green substrate to remove the fluid, such as, heated air convection heating, vacuum freeze drying, solvent extraction, microwave or electromagnetic/radio frequency (RF) drying methods, or a combination thereof. The fluid within the extruded green substrate must not be removed too rapidly from the substrate so that drying cracks due to shrinkage do not form. Typically, for aqueous-based systems, the green substrates can be dried when exposed to temperatures between 90° C. and 150° C. for a period of about one hour, though the actual drying time may vary due to the size and shape of the substrates, with larger parts often taking longer to fully dry. In the case of microwave or RF energy drying, the fluids themselves, or other constituents in the extruded material adsorb the radiation to more evenly generate heat throughout the material. During the fluid-removal step 210, depending on the selection of materials used as additives 130, the materials acting as a binder can congeal or gel to provide sufficient green strength of the substrate for handling purposes.

Once the green substrate is dried, or substantially free of the fluid 130 by the fluid-removal step 210, the next phase of the curing step 170 proceeds to the organic-removal step 220. This phase of the curing step 170 removes any organic components of the additives 130 through pyrolysis or by thermal degradation or volatilization, leaving substantially only the fibers 120 and the inorganic constituents of the additives 130. The organic-removal step 220 can be further parsed into a sequence of component removal steps, such as organic binder burnout followed by pore former burnout, when the organic constituents of the additives 130 are selected such that the curing step 170 can sequentially removes the components. For example, when HPMC, when used as a binder, will thermally decompose at approximately 300° C. When a carbon particle pore former is used, the carbon will oxidize into carbon dioxide when heated to approximately 600-900° C. in the presence of oxygen. Similarly, flour or starch, when used as a pore former, will thermally decompose at temperatures between 300° C. and 600° C. Accordingly, the green substrate using HPMC as an organic binder component of the additives 130 and a carbon particle pore former component of the additives 130 can be processed for organic-removal 220 by subjecting the substrate to a multiple-step firing schedule to remove the binder and then the pore former. In this example, binder burnout can be performed at a temperature of at least 300° C., but less than 600° C. for a period of time, followed by pore former burnout at a temperature of at least 600° C., but less than a devitrification temperature of any of the inorganic constituents, such as the fibers 120 or the inorganic binder of the additives 130. The thermally-sequenced curing step provides for a controlled removal of the additives 130 necessary to facilitate the forming process 160, and those that enhance the final microstructure of the substrate.

Alternatively, the curing step 170 can be sequentially controlled into any number of steps by controlling the environment thermally and/or chemically. For example, the organic-removal step 220 be performed in a first phase to selectively remove a first organic constituent, such as an organic binder, at a certain temperature in an inert environment, by purging the environment with an inert gas such as argon, nitrogen, helium, or by heating in a vacuum environment, or a partial vacuum purged with a low partial pressure of an inert gas. A subsequent phase can burn out a second organic constituent, such as a pore former, by initiating and maintaining the introduction of oxygen into the curing environment. Further, the organic-removal step 220 may need to be controlled, either thermally or chemically, so that any exothermic reactions do not elevate the temperature within the substrate excessively. This level of control can be implemented through process control of the heating environment, or by metering the flow of oxygen into the heating environment.

During the organic-removal step 220 of the curing step 170, as the organic components of the additives 130 are removed, the relative position of the fibers 120 remains substantially the same as when the green substrate is formed during the forming step 160. The fibers are in an intertangled relationship, with the (glass/bentonite) inorganic binder of the additives 130 providing support. As the organic components of the additives 130 are removed, the inorganic components remain, such as the inorganic bonding phase, to provide support for the fibers. Upon completion of the organic-removal step 220, the mechanical strength of the substrate may be quite fragile, and the substrate may require careful handling procedures. It may be advantageous to perform the organic-removal step 220 and the subsequent sintering step 230 in the same oven or kiln to minimize damage to the substrate due to handling.

The final phase of the curing step 170 is the sintering step 230. In this phase, the green substrate, substantially free of the fluid 130 and substantially free of organic components of the additives 130, is heated to a temperature in excess of 1000° C., but less than the liquidous (melting) temperature of the fibers, such as, for example, 1587° C. for aluminosilicate fiber, and typically between 1200° C. and 1500° C., to form bonds between the fibers. For example, in the exemplary embodiment where aluminosilicate fibers are provided as the fiber 120, during the sintering step 230, as the green substrate is heated and held at the sintering temperature, the vitreous aluminosilicate fibers transition into polycrystalline mullite form as the alumina and silica combine into the mullite solid solution with the equilibrium composition limits of between about 60 and 63 mol % alumina, with the remaining silica reacting with the inorganic binder additives 130 to form an amorphous glass. In the exemplary embodiment where polycrystalline mullite fiber is provided as the fiber 120, during the sintering step 230, as the green substrate is heated and held at the sintering temperature, the inorganic additives 130 form glass and/or glass-ceramic bonds between the mullite fibers to form an amorphous glass, and at least partially transition into polycrystalline mullite form.

The fiber-based substrate can also be formed through a reaction of fibers and inorganic binders to fabricate a substrate having a composition that is significantly different than the composition of the fiber 120. For example, a fiber-based cordierite substrate can be formed from cordierite-precursor materials according to an exemplary method described herein. The method may include the use of at least one fibrous cordierite precursor material. Cordierite is a ceramic material with a molecular formula of 2(MgO).2(Al₂O₃).5(SiO₂). Thus, in order to form cordierite, the cordierite-precursor materials may include at least one of magnesia (MgO), alumina (Al₂O₃) and silica (SiO₂). At least one, or any combination, of the cordierite precursor materials may be in fiber form. The fibers can be a single composition, or mixed composition, and possibly all of the cordierite precursor materials can be in fiber form. While, a variety of raw materials may be used to produce cordierite, cordierite content in a final product may be related to the purity of the magnesia, alumina and silica provided by the cordierite precursor materials. The purity of the cordierite precursor materials, as well as the relative content of other materials may vary depending upon the desired composition of the product.

Referring back to FIG. 1 and FIG. 2, the method of forming a porous cordierite substrate may include providing a fiber 120 including at least one cordierite precursor material. For example, alumina fiber, silica fiber, magnesia fiber, magnesia alumina silicate fiber, magnesium silicate fiber, aluminosilicate (including aluminosilicate in the mullite phase) fiber or any combination thereof may be used. The fiber 120 including at least one cordierite precursor material may allow a relatively higher porosity to be achieved. A fiber may be generally defined as a material having an aspect ratio greater than one, as compared to powder, for which the particles may have an aspect ratio of about one. The aspect ratio is the ratio of the length of the fiber divided by the diameter of the fiber. The fibers may be on the scale of 2.0 to 9.0 microns in diameter, with an aspect ratio distribution between about 3 and about 1000, however, fibers having a diameter between 1 and 30 microns can be used, with aspect ratios between 1 and 100,000. In other embodiments, the aspect ratio of the fibers may be in the range of about 3 to about 500. The fibers 120 may be chopped to achieve the desired aspect ration for extrusion

The fibers 120 may be, for example, ceramic oxide fibers or glass fibers in crystalline, partially crystalline or amorphous form. Fibers including at least one cordierite precursor material may include, for example, biosoluble magnesium silicate fibers or magnesia-alumina-silicate fiberglass (e.g., S-glass). The use of a magnesium-based biosoluble fiber may be beneficial because, while most refractory ceramic fibers are typically considered carcinogens and are highly regulated in Europe, magnesium-based biosoluble fibers are not considered carcinogenic. Thus, magnesium-based biosoluble fibers may be easier to obtain and handle for worldwide production of substrates. Similar to the magnesium-based biosoluble fiber, magnesia-alumina-silicate fiberglass may not be a regulated carcinogenic material, so materials for producing fiber-based substrates can easily be obtained for worldwide production. ISOFRAX is a magnesium-based biosoluble fiber that can be obtained from Unifrax Corporation, Niagara Falls, N.Y., though other fibers including magnesium silicate may also be used.

At least one organic binder material may also be provided as an additive 130. Organic binders may typically be polymeric materials that, for example, when added to a suspension of ceramic particles may aid in adjusting the rheology of the suspension, e.g., through dispersion or flocculation of the particles. Water soluble organic binders, such as hydroxypropyl methyl cellulose, may work advantageously for extrusion applications, though other binders or multiple binders may be used. For example, in a suspension that is too fluid for extrusion, a binder may be added to thicken, or increase the apparent viscosity of the suspension. A plastic ceramic material may have a relatively high shear strength, which may facilitate extrusion. In extrusion applications, binders may aid in providing plasticity and obtaining flow characteristics that may aid in extrusion of the material. Additionally, binders may be used to help improve the pre-firing, or green strength of an extruded substrate. While the addition of an organic binder material has been described, other additives may be used to aid in controlling the rheology of the suspension.

The fiber and the at least one organic binder material may be mixed 150 with a fluid 140. Mixing 150 the fibers, organic binder and fluid may enable suspension of the fibers in the fluid. Once the fibers are suspended, the rheology of the suspension may be further adjusted for extrusion as needed. The fibers, organic binder, and fluid may be mixed 150, e.g., using a high-shear mixer, to improve dispersion of the fibers and aid in producing the desired plasticity for a particular processing application, e.g., extrusion. The suspension may include less than about 60 volume percent fiber, resulting in a substrate having greater than about 40% porosity. Deionized water may be used as the fluid for suspension, though other fluids such as ionic solutions may be used.

Additional raw materials may be included in the mixture, e.g., to provide additional cordierite precursor materials, to adjust the rheology of the mixture, to allow the inclusion of other materials in the final structure, and to modify the cordierite content in the final structure. While the fiber may include the stoichiometric amounts of magnesia, alumina and silica necessary to form cordierite, additional raw materials may be added to achieve the desired stoichiometry if the selected fiber is deficient. For example, if a fiber composed of magnesia and silica in a ratio of 2 moles of magnesia per 5 moles of silica is selected, additional raw materials may be needed to provide the alumina necessary for cordierite formation. Similarly, if a fiber composed of magnesia, alumina and silica in a ratio of 2 moles of magnesia and 1 mole alumina per 2 moles of silica is selected, then additional alumina and silica may be needed for cordierite formation. Similarly, if a fiber composed of alumina and silica in a ratio of 2 moles of alumina per 5 moles of silica is selected, additional raw materials may be needed to provide the magnesia necessary for cordierite formation. In such instances, alumina, magnesia and/or silica may be mixed 150 with the fiber, binder and fluid to provide a stoichiometric suspension composition for cordierite formation. The additional alumina, magnesia and silica may be provided in the form of colloidal alumina, magnesia or a magnesia precursor material such as magnesium carbonate, and colloidal silica, though other raw material sources of alumina, magnesia and silica may be used.

Similarly, a pore former material may be mixed 150 with the fibers, binder, and fluid. The pore former may aid in increasing porosity in the final fired substrate. The pore former material may be spherical, elongated, fibrous, or irregular in shape. The pore former may aid in the formation of porosity in a number of ways. For example, the pore former may assisting in fiber alignment and orientation. The pore former may assist in arranging fibers into an overlapping pattern to facilitate proper bonding between fibers during firing. Additionally, during firing of the substrate, the pore former may be substantially burned off. When the pore former burns off during firing, the space that the pore former had occupied may become open, increasing porosity. Graphite, or carbon, powder may be used as a pore former, though other pore former materials may also be used.

The mixture of fiber, organic binder, fluid, and any other materials included in the mixture, may be extruded 160 to form a green substrate (i.e., an unfired extruded article). The extruder may be, for example, a piston extruder, a single screw, or auger, extruder, or a twin screw extruder. In catalytic converter and particulate filter applications, the mixture of fiber, binder, fluid and other ingredients may be extruded 160 through a die configured to produce a honeycomb form.

The green substrate that may be extruded 180 may be cured 170, enabling consolidation and bond formation between fibers and may ultimately form a porous cordierite fiber substrate. Curing 170 may include several processes. The green substrate may be dried 210 in order to remove a substantial portion of the fluid, e.g., through evaporation. The drying 210 process may be controlled in order to limit defects, e.g., resulting from gas pressure build-up or differential shrinkage. Drying 210 may be conducted in open air, by controlled means, such as in a convection, conduction or radiation dryer, or within a kiln.

As the green substrate is heated 220, the organic binder and pore former may begin to burn off. Most organic binders will burn off at temperatures below 500° C. The increase in temperature may cause the hydrocarbons in the polymer to degrade and vaporize, which may result in weight loss. The organic binder burn off may enable fiber-to-fiber contact, and may form an open pore network. A pore former, such as particulate carbon, typically oxidizes and burns off at about 1000° C., further increasing porosity.

The dried green substrate may be sintered 230 to enable the formation of bonds between fibers. Sintering 230 may generally involve the consolidation of the substrate, characterized by the formation of bonds between the fibers to form an aggregate with strength. Several types of bonds may form during the sintering 230 process and the types of bonds formed may depend upon multiple factors, including, for example, the starting materials and the time and temperature of sintering 230. In some instances, glass bonds may form between fibers. Glass bonding is typically characterized by the formation of a glassy or amorphous phase at the intersection of fibers. In other instances, solid state bonds, glass-ceramic bonds and crystalline bonds may form by consolidation of a region between fibers. Solid state, glass-ceramic, and crystalline bonding are characterized by grain growth and mass transfer between overlapping fibers. Glass bonds typically occur at lower temperatures than solid state and crystalline bonds.

While sintering 230 may occur over a range of temperatures, the substrate may be fired at a sufficient temperature for the in-situ formation of cordierite crystals. Powder-based cordierite typically forms between 1400 and 1470° C., depending upon the composition of the mixture of ingredients present during sintering. Over this temperature range, the amount of liquid in the system may rapidly change with small increases in temperature. According to the present disclosure, cordierite may form at a sintering temperature between 1000 and 1470° C., depending upon the composition of the mixture of fibers and other ingredients present in the substrate during sintering. Firing may be controlled based upon the amount of magnesia, alumina and silica in the green substrate in order to ensure optimal conditions for cordierite formation. During firing, the magnesia, alumina and silica in the substrate may combine and crystallize to form cordierite, resulting in a highly porous fiber-based cordierite substrate.

Referring still to FIG. 1 and FIG. 2, a fiber-based silicon carbide substrate can be reaction formed using carbon fiber 120, (carbonaceous type fiber) additives 130, and a fluid 140 in a mixing step 150, that is then formed 160 into a honeycomb form, where the carbon fibers 120 and the additives 130 are reaction formed into silicon carbide fibers 160. By forming silicon carbide fibers in-situ, the commercial economic advantages of mixing and extruding compliant, low cost materials are realized as a low-cost implementation of a high performance ceramic substrate material.

The carbon fiber 120 can be Polyacrilnitrizile (PAN) fibers or Petroleum Pitch fibers, of the type commonly used in carbon-fiber reinforced composites, or a variety of carbonized organic fibers such as polymeric fibers, rayon, cotton, wood or paper fibers, or polymeric resin filaments. The carbon fiber diameter can be 1 to 30 microns in diameter, though for intended applications such as exhaust filtration, a preferred range of fiber diameter is 3 to 10 microns can be used. The fiber diameter and length is not materially changed in the subsequent formation of silicon carbide, and thus, the selection of the carbon fiber characteristics should generally match the desired fiber structure of the final product. PAN or Pitch fibers, and carbonized synthetic fibers, such as rayon or resin, will have more consistent fiber diameters, since the fiber diameter can be controlled when they are made. Naturally occurring fibers, such as carbonized cotton, wood, or paper fibers will have an increased variation and less-controlled fiber diameter. The carbon fibers 120 are typically chopped or milled to any of a variety of lengths for convenience in handling, and to ensure even distribution of fibers in the mix. It is expected that the shearing forces imparted on the fibers during the subsequent mixing step 150 will shorten at least a portion of the fibers, so that the fibers have a desired length to diameter aspect ratio between 1 and 1,000 in their final state after extrusion, though the aspect ratio can be expected to be in the range of 1:100,000.

The additives 130 include at least two primary groups of constituents: silicon-based particles, such as silicon metal particles or silicon oxide (silica) particles, such as colloidal silica; and a binder. In some cases, a chemical carrier, such as silicon-containing polymers, or solutions, etc, may also be used to provide silicon into the system to react with the carbon to form silicon carbide. The silicon-based particles or chemical or polymer solutions are necessary to react and combine with the carbon within the fibers to form silicon carbide fibers when heated under appropriate temperature and environmental conditions (vacuum or inert atmosphere). The binder, plasticizers, etc are necessary to provide plasticity in the mixture and to provide adequate cohesive forces in the extruded body to form the honeycomb substrate, such as in the extrusion process 160. The additives 130 may also include plasticizers, dispersants, pore formers, processing aids, and strengthening materials to further manipulate the chemistry, porosity, pore-size, pore structure, mechanical and thermal characteristics. As will be discussed, the selection of the additives must be made so as to not inhibit the desired formation of silicon carbide from the silicon-based particles and the carbon fiber 120.

In order to form silicon carbide fibers from the carbon fibers 120 and the additives 130, the silicon content of the silicon-based particles must be provided in approximately a stoichiometric ratio to form silicon carbide, and evenly distributed throughout the extruded or formed substrate. Silicon-based particles can be material provided in the form of silicon metal particles, fumed silicon, silicon microspheres, silica-based aerogels, polysilicon, silane or silazane polymers, or from other silicon-based compounds, such as amorphous, fumed, or colloidal silicon dioxide (silica). Colloidal silica can also be used for the silicon-based component of the additives 130. Colloidal silica is a stable dispersion of discrete particles of amorphous silica (SiO₂), sometimes referred to as a silica sol. Colloidal silica is commercially available with particle sizes between 5 nm and 5 μm dispersed in an aqueous or solvent solution, typically around 30-50% solid concentration. The small particle size of colloidal silica, when mixed with the carbon fibers 120, permits a uniform distribution of the silicon-based component with the carbon fiber, so that the silica can effectively coat the surface of the individual carbon fibers. The stoichiometric ratio of silicon carbide will be attained with a ratio of three parts carbon to one part Silica (3:1), though the ratio of materials added to the mixture can include excess carbon or excess silica, for example, the mixture can be in the range of about 5:1 and 2:1 carbon:silica.

Alternatively, the silicon-based constituent of the additives 130 can be silicon metal particles with a sufficiently fine particle size to be fully and evenly dispersed during processing. Purity of the silicon is not essential for the silicon carbide formation reaction to occur, but metallic contaminants may alter the application and effectiveness of any subsequent catalyst layer. Preferably, the particle size of the silicon-based constituent of the additives 130 is as small as commercially available. Silicon powder in the 1 to 4 μm size or silicon nanoparticles are desirable, though lower cost materials are typically associated with particles in the 30 to 60 μm size. The larger particles are sufficiently small enough to be effectively distributed for the formation of silicon carbide. The stoichiometric molar ratio of silicon carbide will be attained with a ratio of about 1:1 carbon:silicon, though the ratio can be extreme, resulting in either excess carbon or excess silicon. Excess silicon is advantageous to make up for silicon or silicon monoxide that may be lost during the process (due to volatility at high temperatures), and/or to provide available silicon for metal bonds. Additionally, excess silicon residing on the formed silicon carbide fibers can act as a protective coating, which can be advantageous when used with catalysts that include materials such as potassium that can otherwise chemically degrade the silicon carbide material.

The additives 130 include a binder component that is necessary to provide plasticity and extrudability of the mixture. The binder provides green strength of the substrate until the final silicon carbide fibrous structure is fully formed in the curing step 170, by retaining the relative position of the carbon fibers 120 and the silicon-based constituents of the additives 130 in the mixture. As will be explained in further detail below, the binder must be selected so that it can be selectively removed from the mixture during the subsequent curing process 170 without inhibiting the desired formation of silicon carbide from the silicon-based particles and the carbon fiber 120. Acceptable binders include methylcellulose, hydroxypropyl methylcellulose (HPMC), ethylcellulose and combinations thereof. In some cases, a binder system that can be thermally disintegrated by converting into volatile species in small or insignificant amount of external oxygen supply can be used. HPMC is a water-soluble polymer that facilitates particle distribution during the mixing step 150 and provides sufficient lubricity and plasticity of the mixture for extrusion of honeycomb forms in the extrusion step 160. For non-aqueous solutions, additives such as ethylcellulose add plasticity to the mix and serves as good extruding aids.

Additives 130 optionally include pore formers, bonding agents and other processing aids. Pore formers, when included as an additive 120, are non-reactive material that occupy space during mixing and extrusion, though are removed eventually via pyrolysis or by thermal degradation or volatilization. For example, microwax emulsions or phenolic resin particles can be added as an additive 120, that will burn out during the subsequent curing process 170, resulting in increased porosity of the resulting structure. Additionally, bonding agents can be included as an additive 120 that remain within the resulting structure contributing to fiber-to-fiber bonds between adjacent fibers. Bonding agents can form metal bonds through the addition of particles of aluminum, titanium, or excess silicon, or glass/ceramic bonds through the addition of an oxide-based ceramic or clay, such as alumina, zirconia, or a clay such as benonite. Bonding agents, as well as the silicon-based additives can also act as pore formers when they are provided in a low density form, such as hollow spheres or aerogels.

The fluid 140 is added as needed to attain a desired rheology suitable for extrusion, or other desired shape formation at step 160. Water is typically used, though solvents of various types can be utilized, along with liquids associated with additives such as colloidal silica, silanes or silazane reagent liquids. Rheological measurements can be made during the mixing process 140 to evaluate the rheology of the mixture compared with a desired rheology for the extrusion step 160.

The carbon fibers 120, additives 130, and fluid 140 are mixed at step 140 to evenly distribute the materials into a homogeneous mass with a desired rheology for extrusion, or other shape forming processing. This mixing may include dry mixing, wet mixing, shear mixing, and kneading, which is necessary to evenly distribute the materials into a homogeneous mass while imparting requisite shear forces to break up and distribute or de-agglomerate the fibers, particles and fluid. The amount of mixing, shearing, and kneading, and duration of such mixing processes depends on the selection of fibers 120, additives 130, and fluid, along with selection of mixer type 130 in order to obtain a uniform and consistent distribution of the materials within the mixture, with the desired rheology suitable for extrusion using piston or screw extruders.

Extrusion of ceramic materials is generally considered to be the most cost efficient method for producing honeycomb ceramic substrates. Other methods of forming honeycomb substrates are known to one skilled in the art, such as casting, injection molding, broaching, and others, which are contemplated to fall within the scope of the appended claims. For the purposes of this description, the method for shaping the mixture into a honeycomb substrate form will be described as the preferred extrusion process.

The extrusion process for the mixture of carbon fibers 120, additives 130, and a fluid 140 according to the present invention is similar to the extrusion of powder-based ceramic materials. The mixture containing a suitable plasticizing aid such as HPMC, and having a suitable rheology, is forced under pressure through a honeycomb die to form a generally continuous honeycomb block that is cut to a desired length. The honeycomb die determines the size and geometry of the honeycomb channels, and can be rectangular, triangular, hexagonal, or other polygonal shaped channels, depending on the design of the extrusion die. The extrusion system used for the extrusion step 160 can be of the type typically used to extrude powder-based ceramic materials, for example, a piston extruder or screw-type extruder. One skilled in the art will appreciate that certain aspects of the mixing step 150 can be performed in a screw extruder during the extrusion step 160. The extrusion step 160 produces a green substrate, which has sufficient green strength to hold its shape and fiber arrangement during the subsequent curing step 170.

Extruding the extrudable mixture of carbon fiber 120, additives 130 and fluid 140 creates a unique microstructure of intertangled fibers in a honeycomb substrate. Shear forces that act upon the material as it is forced through the die result in a tendency for orientation of the fibers in the direction of extrusion along the wall surface of the honeycomb channels. Within the channel walls, the fibers are generally aligned in the extrusion direction due to the shear forces imparted on the material during extrusion, but the alignment can be less than the alignment of the fibers at the wall surface. The resulting microstructure has an even distribution of relatively small spacing between the aligned fibers at the surface of the channel wall, with a broader range of spacing between fibers within the channel walls. After the subsequent curing step 170, when the binder and fluid is removed while maintaining the relative fiber spacing throughout the substrate, the resulting structure becomes porous. The porosity of the substrate, as a result of the alignment of the fibers during extrusion, exhibits an even distribution of small pores at the channel walls, with a broader distribution of pores within the open network of pores resulting from the spacing between fibers. Additionally, while the surface of the channel walls can be viewed as a two-dimensional mat of interlocked and interconnected fibers, distinguished by the internal regions of the channel wall, which is a three-dimensional structure of interlocked and interconnected fibers, the surface of the channel walls is not entirely planar. Fiber ends have a tendency to protrude out at an angle from the surface. These protrusions are particularly useful when the substrate is used as a filter, such as a diesel particulate filter, since the protrusion can act as nucleation, coagulation or trapping sites for cake filtration. The distribution of these sites over the surface of the channel walls ensures that a uniform accumulation of particulates can accumulate, which acts to improve trapping efficiency and to regulate regeneration of the filter.

The alignment of fibers, pore size, pore distribution, nucleation, coagulation, and trapping site distribution, and pore characteristics between wall surface and internal regions can be controlled by altering parameters of the extrusion process. For example, the rheology of the mixture, diameter and aspect ratio distributions of the fibers, characteristics of the additives, extrusion die design, and extrusion pressure and speed can be varied to attain desired characteristics in the resulting structure of the substrate.

The curing step 170 effectively converts the carbon fiber 120 that is mixed with the silicon-based additives 130 within the green substrate into silicon carbide fibers while maintaining the honeycomb structure formed by extrusion. The curing step 170 can be performed as the sequence of three phases: drying 210; binder burnout 220; and reaction-formation of SiC 230. In the first phase, the green substrate is dried by removing the fluid using relatively low temperature heat with or without forced convection to gradually remove the water. Alternative methods of drying can be implemented, such as vacuum freeze drying, solvent extraction, or electromagnetic/radio frequency (RF) drying methods. The use of RF to dry the green substrate can be challenging due to the conductivity of the ceramic fibers, thus requiring controlled modulation of the RF power. The fluid must not be removed too rapidly from the substrate so that drying cracks due to shrinkage do not form. Typically, for aqueous based systems, the green substrates can be dried when exposed to temperatures between 90 and 150 degrees Celsius for a period of about one hour, though the actual drying time may vary due to the size and shape of the substrates, with larger parts often taking longer to fully dry.

Once the green substrate is dried 210, or substantially free of the fluid 140, the next phase of the curing step 170 proceeds to burn out the binder component of the additives 130. In this second phase, the substrate is heated in an inert environment to a temperature that will effectively decompose the binder, without affecting the compositions of the carbon fiber and the silicon-based component of the additives 130. For example, if methylcellulose or HPMC is used for the binder component of the additives 130, this binder will decompose at a temperature of approximately 300 degrees Celsius, and effectively burn out when held at that temperature for approximately one hour. It is important to note that other additives, such as pore formers, plasticizers, and dispersants must be selected so that they either decompose completely or leave a controlled residual carbon layer behind that can be used in the subsequent SiC reaction. Binders and additives should be chosen such that decomposition of the binders, as well as the elimination of any crystalline water from additives such as clay should takes place at temperatures less than 800° C. The resulting structure of the substrate at this phase of the curing step 170 results generally with the carbon fibers 120 being coated with an even distribution of small particles, or an even coating, of the silicon-based component of the additives 130.

The final stage of the curing process 170 requires sintering 230 the remaining structure, i.e., the carbon fiber and the silicon-based component of the additives in an environment sufficient to form silicon carbide from the carbon fibers. The chemical reaction during this final phase of the curing step 170 is generally described to be:

C+Si→SiC

though when the silicon-based component is silica, the reaction can be described to be:

3C+SiO₂→SiC+2CO₂

It is to be appreciated that in this reaction, intermediate transitionary compounds may form before stable SiC is formed.

The above reaction will take place when the structure is heated to a temperature of about 1400 to 1800 degrees Celsius, for approximately 2 to 4 hours or more, in an inert environment. When silicon metal is included as the silicon-based component of the additives 130, the silicon particles will melt at above 1414 degrees Celsius, which will then wet to, and coat the carbon fibers to convert into silicon carbide. This wetting is optimized in vacuum atmosphere conditions where silicon metal will spontaneously wet elemental carbon, including the fiber itself or wetting of a residual carbon layer remaining from the burn out of a binder additive.

When silica is included as the silicon-based component of the additives 130, there is a solid state (solid-solid) reaction that goes on that is diffusion dependent:

3C+SiO₂→SiC+2CO₂

There may be a secondary reaction is that the SiO₂ first vaporizes to SiO, and this then reacts with the carbon to form silicon carbide, thus resulting in the following gas-solid reaction:

2C+2SiO→2SiC+O₂

An inert environment is necessary ensure the absence of oxygen to prevent the oxidation of the carbon into carbon dioxide. It can be appreciated that the resulting microstructure formed within the substrate is largely based on the intertangled fiber architecture originally composed of the carbon or organic fibers, and the formation of silicon carbide during the curing step 170 does not substantially change the relative position of the fibers.

The curing step 170 can be carried out in a conventional batch or continuous furnace or kiln. The inert environment can be maintained by purging the furnace or kiln with nitrogen, argon, helium, neon, forming gas and mixtures thereof, or any inert gas or gaseous mixture. It is important to have a little to none partial pressure of oxygen, so as to prevent adverse reactions from occurring that can lead to oxidation and volatilization of the reactive species. Alternatively, the curing step 170 can be performed in a vacuum environment, which would typically require a vacuum of 200.0 torr or less. The curing step 170 can be performed by a sequential progression through multiple batch or continuous kilns, or the sequence of heating steps, i.e., drying, binder burnout, and reaction formation, can be performed in a single facility that can maintain the sequential temperature environments in a manual or automatic fashion.

### B. Examples of Observed Substrate Performance Characteristics

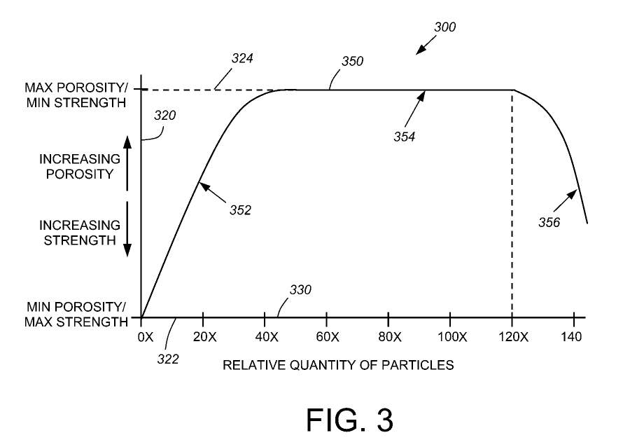

The actual composition and thermal and chemical properties of the resulting structure depends upon the selection of the fiber, the inorganic binder and the sintering time and temperature. For example, and with further reference to the graph 300 of FIG. 3, the relative quantities of particles, e.g., the weight percentage of pore former, applied to the initial mixture of components has a direct relationship on the strength (as measured by MOR or crush strength) of the final, cured/sintered substrate as well as the porosity of the substrate. Generally, it has been recognized that the more porous the substrate (subject to the further variables described hereinbelow), the less the strength and vice, versa. Thus the graph's vertical axis 320 represents increasing porosity between a respective minimum and maximum value lines 322, 324 (for example between approximately 0-10% and 60-70% porosity with respect to substrate volume) in the upward direction. The vertical axis also represents decreasing strength between the associated minimum and maximum value lines 322, 324 (for example, between approximately 400 psi and 1200 psi). The minimum and maximum values of strength and porosity are exemplary only. The horizontal axis 330 represents the initial mixture weight percentage of pore former (carbon/graphite in this example) between 0× and approximately 140×, where × is an amount relative to other components in the mixture on a dry-weight basis (without water added). The curve 350 reflects the observed variation in strength with respect to the quantity of pore former in the mixture. While there may be slight deviation between observed strength and observed porosity within each respective scale over the full span of the curve 350 (i.e. the strength and porosity curves may diverge slightly), the unified increased-porosity/decreased-strength curve 350 serves as an illustrative example of the observed inverse relationship between these two performance characteristics. Thus, various graphs and curves described herein will employ this representation to describe the joint effect on strength/porosity by varying particular mixture components and process variables.

Referring more particularly to the curve 350 of the graph 300, the front end 352 near the origin (0× pore former) shows a sloped rise in increased-porosity/decreased-strength to the maximum line 324, which occurs at approximately 60× or more. As more pore former is added, to a point, it tends to create more pores. The central segment 354 of the curve 350 exhibits maximum porosity without substantial decrease in strength until approximately 120× pore former. Within this segment, the pore former fully mingles with the fibers. Thereafter the trailing end 356 of the curve 350 exhibits a decline in the increased-porosity/decreased-strength value as the pore former begins to dominate the space and clumps together, causing large voids and less interconnection between fibers. Thus, to ensure maximum porosity without compromising the strength a designer may be motivated to add up to approximately 120× pore former to the mixture.

Referring still to the curve 350 of the graph 300, in a reaction-bonded substrate system such as in-situ cordierite, silicon carbide, or other reaction-formation compositions, the relative quantity of reactive constituents can also be modified to influence the resulting strength and porosity of the substrate.

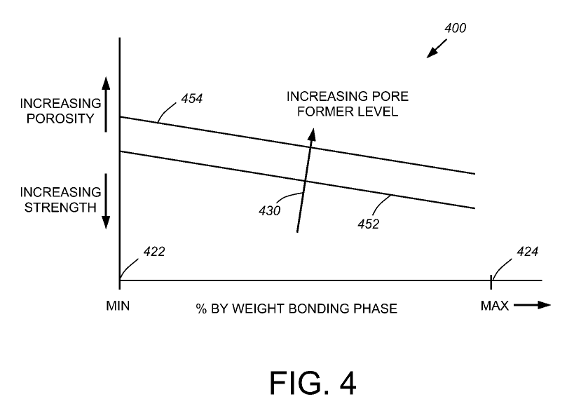

The variation of other components may affect the observed porosity/strength characteristics of the cured/sintered substrate as indicated in the graph 400 of FIG. 4. In this graph, the quantity of glass/bentonite-based bonding phase is varied between a minimum and a maximum percentage (for example, between approximate 12% and 20%)—horizontal axis points 422 and 424. Within the minimum and maximum quantities 422, 424, the generalized curve for porosity/strength exhibits a downward slope, meaning that more bonds are formed, increasing strength and decreasing porosity. However, as shown, the increase in pore former produces an observed secondary effect. The arrow 430 represents an increase in pore former between 40-60% and the maximum of approximately 120%. This derives a lower curve 452 for a minimum amount of pore former and a higher curve of somewhat similar downward slope for a maximum amount of pore former. Thus, by carefully blending relative quantities of bonding phase and pore former a desired porosity/strength can be achieved.

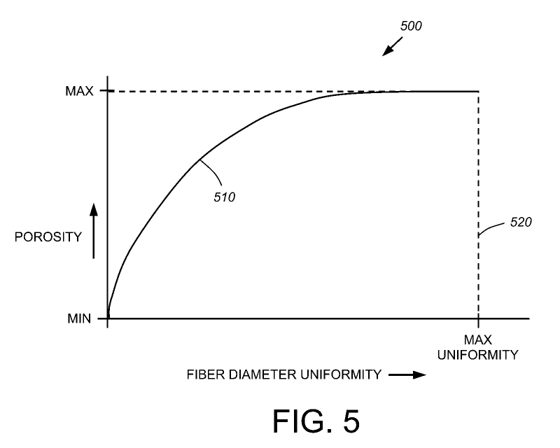

The effects of other component quantities and characteristics in the initial mixture have also been observed in the resulting substrate. As shown in the graph 500 and curve 510 of FIG. 5, within limits, the porosity increases as the diameter of fibers in the mixture become more uniform. When all fibers have the same diameter, porosity, based upon this variable, reaches it maximum level 520. Of course, porosity is affected by other variables as described above and as described further below.

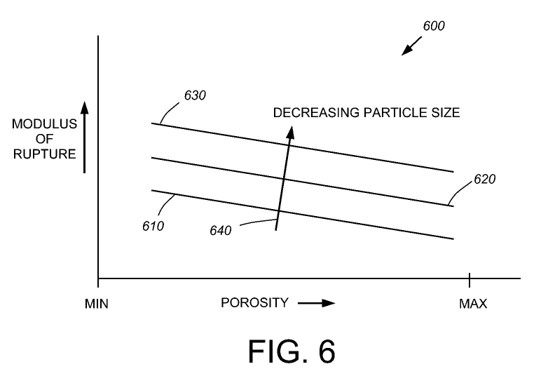

As shown in the graph 600 of FIG. 6, the actual relationship between observed porosity and strength (defined by MOR or crush strength) is, itself affected by the size of particles used in the additives 130, such as, for example, pore former particles, or alternatively, reactive particle constituents including precursor additives 120, such as silicon metal particles in an in-situ silicon carbide substrate or magnesium oxide in a cordierite fibrous substrate. The multiple curves 610, 620, 630 all reflect the decrease in strength with increasing porosity, but the overall strength as a function of porosity can be increased by reducing the size of particles (upward arrow 640) between minimum and maximum mesh sizes. Of course, the particles should be maintained within a predetermined mesh size range so that the resulting pores can trap appropriate sized filtrates, but within that range, a smaller sized particle yields more bonds and more pores, thereby increasing strength—other variables being relatively equal.

### C. Mixture Components and Their Controllable Factors

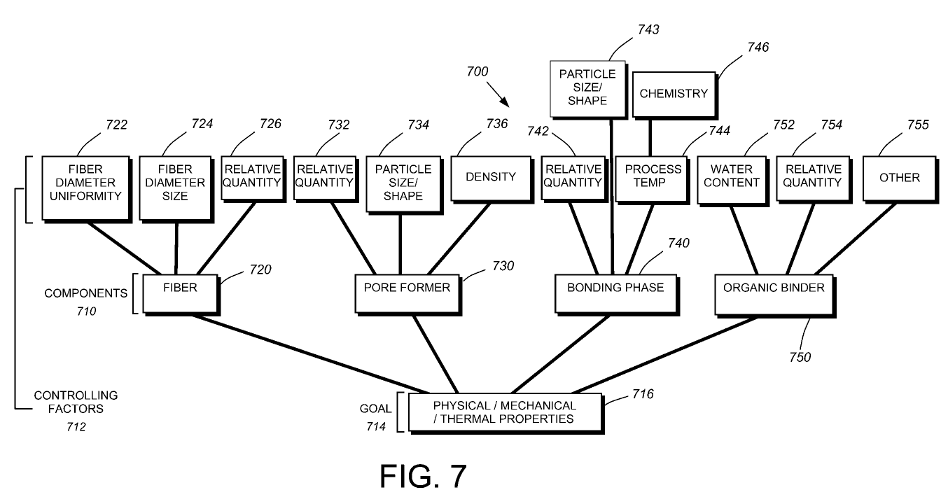

The above-described observations are illustrative of a range of possible variations in the initial mixture components and fabrication parameters. FIG. 7 is a diagram 700 that includes a generalized summary of the main components 710 of the initial mixture and the controlling factors 712, which can be varied for those respective components to achieve the desired goal 714 of optimized physical/mechanical/thermal properties, such as (typically) porosity/strength/CTE within the cured/sintered substrate. The following is a discussion of the various initial mixture components, the factors that may be controlled and the resulting performance changes in the cured/sintered substrate.

As discussed generally above, a principle component in the initial mixture, forming the structural matrix of the cured/sintered substrate is the fiber component 720. In an illustrative embodiment, mullite is the fiber employed, but other fiber substances can be employed in alternate embodiments. Three main controlling factors can be varied with respect to the fiber component 720, including the fiber diameter distribution (degree of diameter uniformity) 722, the average fiber diameter size and aspect ratio (diameter-to-length) 724, and the relative quantity 726 of the fiber in the mixture (e.g., weight percent). For example, fibers produced using processes that tightly control the fiber diameter—i.e., fibers exhibiting a narrow distribution of fiber diameter—will provide fiber-based substrates having improved strength and/or porosity.

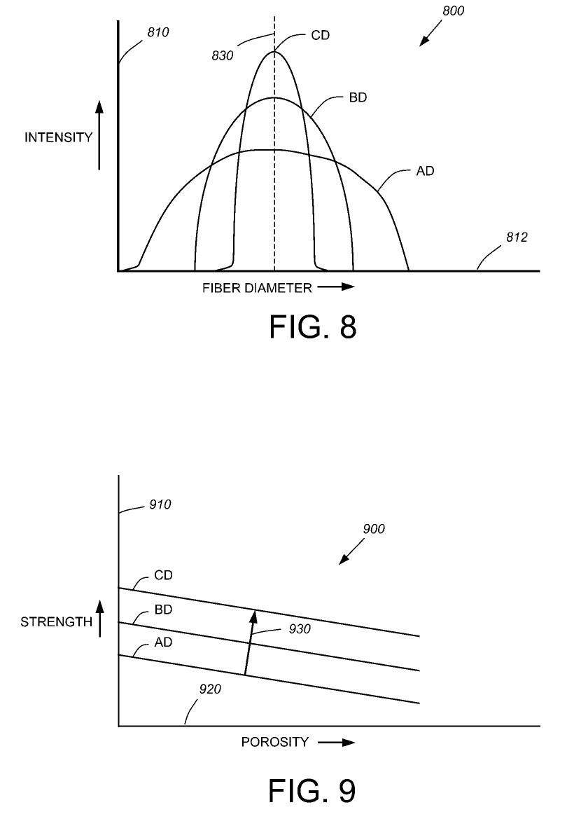

Reference is made to the graph 800 of FIG. 8, which shows the distribution of fiber diameter in a mixture by plotting intensity or counts (vertical axis 810) versus fiber diameter (horizontal axis 820). Three exemplary curves AD, BD and CD, each representing an increasingly more-uniform particle diameter are shown centered around an optimal particle diameter (if any) represented by dashed line 830. The results of controlling the factor of uniformity of fiber diameter distribution is, thus shown in the graph 900 of FIG. 9. As shown, the three fiber-diameter-distribution curves AD, BD and CD are plotted on the basis of strength (vertical axis 910) versus porosity (horizontal axis 920). While each curve has a similar downward slope, the increased uniformity of fiber diameter sizes (arrow 930) translates into a generally higher strength for a given porosity (curve CD).

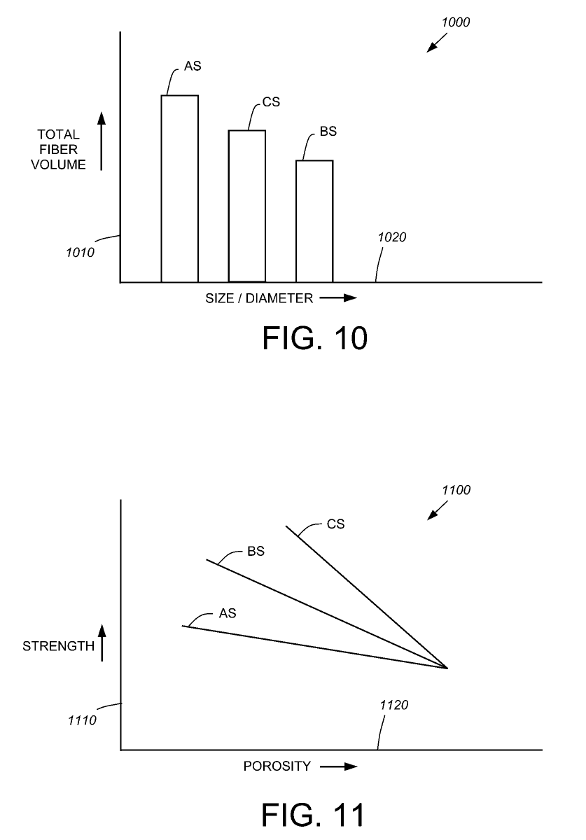

With respect to the fiber aspect ratio as a controlling factor, reference is now made to FIG. 10, which shows a graph 1000 with three discrete, exemplary distributions of average fiber particle diameter size (horizontal axis 1020) for a given volume of fibers in the mixture (vertical axis 1010) for a given fiber composition density. The three curves represent a smallest accepted diameter (curve AS), a maximum accepted diameter (curve BS) and an intermediate fiber diameter (curve CS). With further reference now to the graph 1100 of FIG. 11 in which the three distributions of particle diameter size AS, BS and CS are plotted for strength (vertical axis 1110) versus porosity (horizontal axis 1120). While each curve, AS, BS and CS sloped downwardly, as expected, the intermediate-diameter fiber particle (curve CS) shows the generally highest performing ratio of strength to porosity through most of the curve, while the larger-diameter particle (curve BS) exhibits lower performance, and the smallest particle (curve AS) exhibits a relatively low strength through the entire range of porosity values.

Note that fiber aspect ratio length-to-diameter also affects the porosity/strength curve for the sintered substrate within predetermined limits. In general, fiber aspect ratio is difficult to control, as the mixing process parameters, and preprocessing (chopping of fibers) procedure contributes to the altering the distribution of fiber lengths in the substrate. Observation appears to support the belief that longer fibers induce greater fiber alignment in the substrate-extrusion process. For example, longer fibers tend to align the fibers in the extrusion direction. This will affect the substrate pore structure (porosity), and pore distribution, and possibly strength (greater axial strength than radial, perhaps). Conversely, shorter fibers may tend to have a closer-packed and random arrangement.

More particularly, the fibers selected for use in the mixture should be processed to have a proper aspect ratio distribution. This aspect ratio is preferred to be in the range of about 3 to about 500 (length-to-diameter) and may have one or more modes of distribution (e.g. bimodal or multi-modal). It will be appreciated that other ranges may be selected, for example, to about an aspect ratio of 1000. In one example, the distribution of aspect ratios may be randomly distributed throughout the desired range, and in other examples the aspect ratios may be selected at more discrete mode values. It has been found that the aspect ratio is an important factor in defining the packing characteristics for the fibers. Accordingly, the aspect ratio and distribution of aspect ratios is selected to implement a particular strength and porosity requirement. Also, it will be appreciated that the processing of fibers into their preferred aspect ratio distribution may be performed at various points in the process. For example, fibers may be chopped by a third-party processor and delivered at a predetermined aspect ratio distribution. In another example, the fibers may be provided in a bulk form, and processed into an appropriate aspect ratio as a preliminary step in the extrusion process.

It will also be appreciated that the mixing, shear mixing or dispersive mixing, and extrusion aspects of substrate-fabrication process may also contribute to cutting and chopping of the fibers. Accordingly, the aspect ratio of the fibers introduced originally into the mixture will typically be different than the aspect ratio in the final cured substrate. Thus, the chopping and cutting effect of the mixing, shear mixing, and extrusion should be taken into consideration when selecting the proper aspect ratio distribution introduced into the process.

For the purposes of this description, the term “fiber” can be defined broadly as a particle that in a cured matrix forms the sintered/cured substrate, and that defines a length-to-diameter aspect ratio of greater than one. This thereby distinguishes “fibers” from other particles that may have a regular or irregular shape that is less elongated.

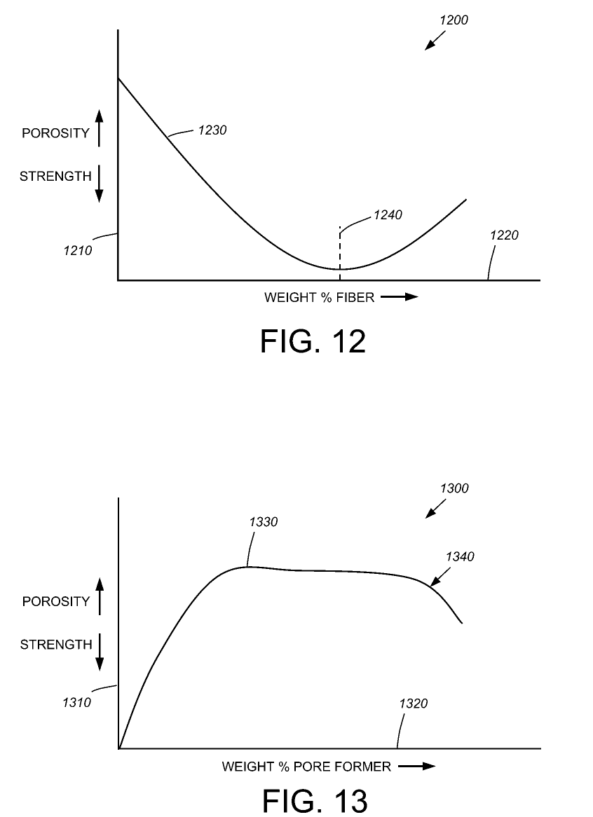

Referring now to the controlling factor relative quantity of fiber weight as a percentage of the total initial mixture (block 726), the graph 1200 of FIG. 12 plots increasing porosity/decreasing strength (vertical axis 1210) versus increasing weight percent of fiber (horizontal axis 1220). The resulting curve 1230, taken between minimum and maximum observed values for strength and weight percent exhibits an inverted curve. That is, the optimum strength occurs at an intermediate point (line 1240) between fiber weight percent extremes.

Referring again to the controlling factor diagram 700 of FIG. 7, the next illustrative component of the initial mixture is the pore former 730, which can be, for example, carbon or graphite particles in an illustrative embodiment. Other volatile, typically organic, pore formers can be used in alternate embodiments. The three controlling factors in connection with the pore former component are the relative quantity 732 of pore former (e.g., weight percent in the mixture), the pore former particle size and shape 734 and the pore former compound relative density 736. The effect of varying weight percentage, i.e., variation of relative quantities of weight percentages, is represented by the previously described relationship in the graph 1300 of FIG. 13, which plots porosity/strength (vertical axis 1310) versus increasing pore former weight percent (horizontal axis 1320). The resulting curve 1330 illustrates the above-described curve shape (see FIG. 3) with a flattened mid-segment 1340 where the increase of pore former alone does not significantly vary the strength/porosity value and decrease strength/porosity after certain amount of pore former addition. This decreasing strength/porosity after a certain amount of pore former addition can be attributed to the displacement of the fiber with pore former such that the pore former becomes at least part of the dominate matrix in the system.

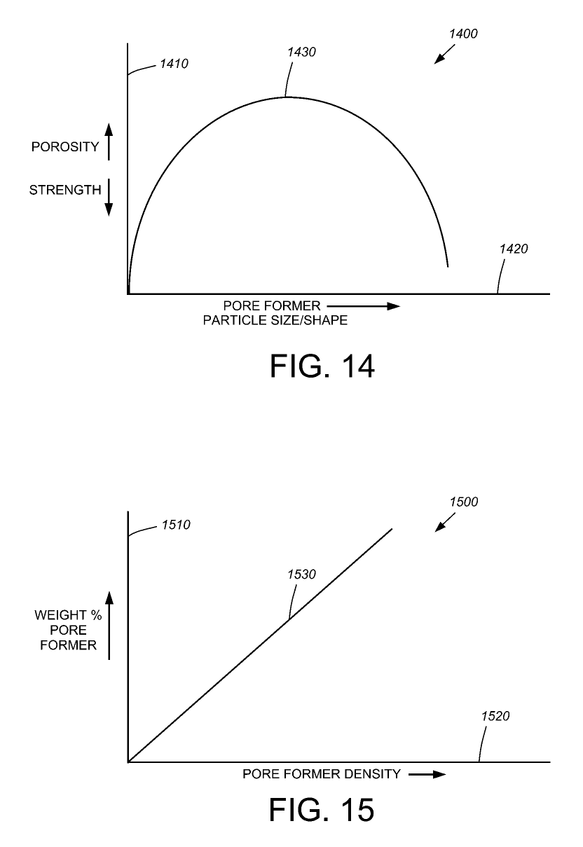

The graph 1400 of FIG. 14 represents the effect of increasing the particle size and shape (horizontal axis 1420) versus observed porosity/strength (vertical axis 1410) (factor block 734). The resulting curve represents a curve with the optimal porosity/strength residing in the middle of the accepted range of particle sizes.

Referring to pore-former-controlling factor 736, graph 1500 of FIG. 15 illustrates the relationship of increasing pore former compound density (horizontal axis 1520) versus increasing weight percent of pore former in the mixture (vertical axis 1510). The observed curve 1530 slopes upwardly as a linear curve between accepted density levels. In general, a higher pore former particle compound density results in a higher weight percent for the same number of particles. Thus, density must be taken into account when measuring out the amount of pore former to add to the mixture. Higher-density particles will require a higher weight percent to achieve the same volume percent of pore former to, thereby, attain the same porosity (which is largely determined by the relative quantity of pore former particles in the mixture). Compensating for density, the weight percentage versus porosity/strength is then determined according to the graph 1300 of FIG. 13.

Referring now to the bonding phase component 740, illustrative controlling factors are the glass/bentonite bonding phase relative quantity 742 (e.g., weight percentage) the particle size distribution 743 of the additives 130 and the processing temperature 744 (e.g., to modify the viscosity of the glass component at the sintering temperature). The sinterability/bonding strength is related to the general chemistry 746 of the glass component and the temperature 744 at which the curing processes are performed. In other words, the relative amounts of bentonite, glass precursors, and other known additives with respect to the silica-based material can be modified, and the processing environment can be modified, in order to determine or influence the resulting physical, mechanical, and thermal properties of the porous substrate. Similarly, with respect to a reaction-formation system, the relative quantity 742, chemistry 746, processing temperature 744, and particle size distribution 743 of the additives 130 or bonding phase 740 can determine the resulting physical, mechanical, and thermal properties of the resulting substrate.

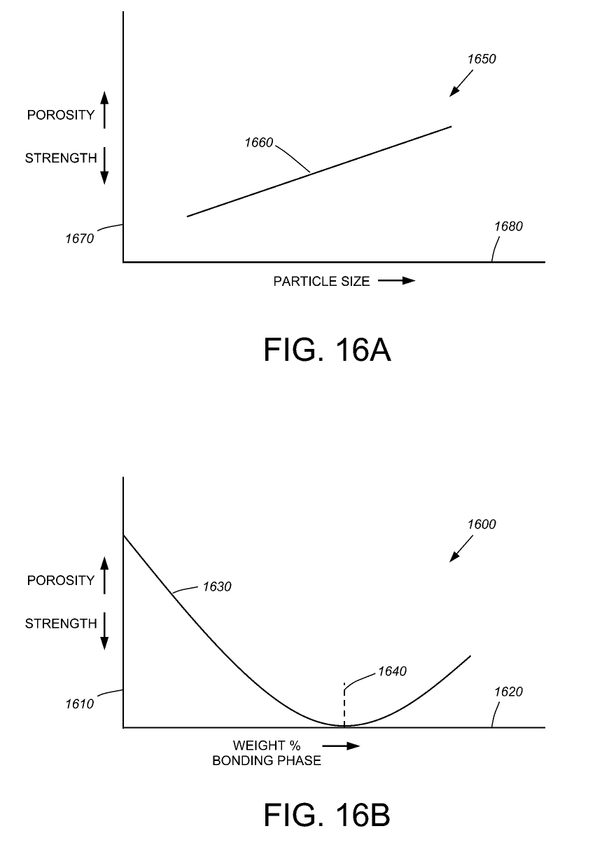

Referring now to the graph 1650 of FIG. 16A, the relationship between increasing particle size of the additives 130 (horizontal axis 1680) and porosity/strength (vertical axis 1670), is illustrated with the curve 1660. As shown, larger particle sizes results in increased porosity, with reduced strength. Smaller particles, when mixed with the fiber, can be distributed throughout the mixture while enabling a closer, denser packing of the fibers.

Referring now to the graph 1600 of FIG. 16B, the relationship between increasing mixture weight percentage of bonding phase component (horizontal axis 1620) and porosity/strength (vertical axis 1610), is illustrated with the curve 1630. As shown, strength increases to an optimal point 1640 with increasing bonding phase, while it decreases when excessive bonding phase is present.

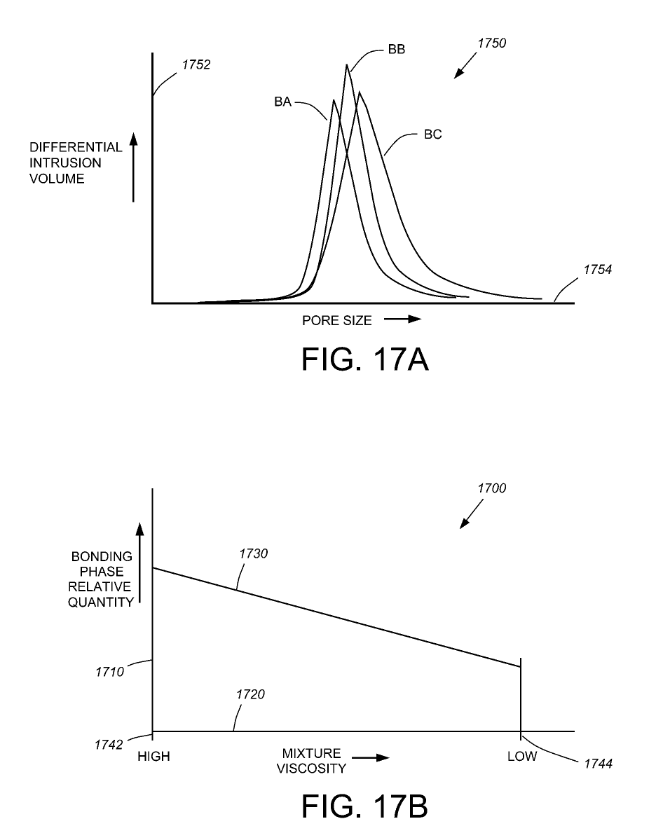

Referring now to the graph 1750 of FIG. 17A, the relationship between particle size is shown as a function of resulting pore size 1754 of the substrate as determined by an analysis of mercury intrusion 1752 (i.e., characterization of the effective diameter of pores within the substrate by measuring the amount of mercury intrusion into the pore structure of the substrate). Three curves are shown: BA representing the analysis of a substrate formed using small particles; BB representing the analysis of a substrate formed using medium sized particles; and BC representing the analysis of a substrate formed using large particles. The smaller particles provide a smaller average pore size with the larger particles providing a larger effective pore size.

Varying sinterability/bonding strength through chemical composition of the bonding phase/additives (block 746) and processing temperature (block 744) provides the graph 1700 of FIG. 17B. The sinterability/bonding strength (horizontal axis 1720 running from high to low) is plotted versus the relative weight percent of bonding phase in the mixture (vertical axis 1710) to define a curve 1730. The curve 1730 slopes downwardly whereby the amount of bonding phase in the mixture generally decreases as sinterability/bonding strength as sinterability/bonding strength decreases, within predetermined minimum and maximum range values 1742, 1744, respectively. The actual sinterability/bonding strength measurement is partially a function of the glass chemistry (block 746)—that is, the formulation of bentonite (or other clay) glass and other additives. How a given sinterability/bonding strength translates into a given glass weight percentage can be determined experimentally or empirically. Once a viscosity value is determined, the resulting weight percentage of bonding phase can be used to determine porosity/strength in accordance with the graph 1600 of FIG. 16.

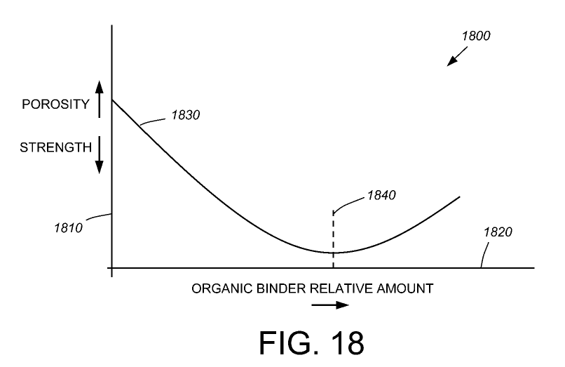

Referring once again to FIG. 7, the organic binder component (HPMC in this example) 750 also affects the resulting physical/mechanical/thermal properties 716 (e.g., strength and porosity). Its main controlling factors include the initial mixture's water content 752 and the relative quantity 754 (e.g., weight percent of HPMC or other acceptable organic binder) in the mixture. Other factors 755, such as lubricants or other components of the organic binder 750 can be added to impact the resulting substrate performance and structure. An illustrative example using HPMC weight percent is shown in FIG. 18. The graph 1800 of FIG. 18 plots porosity/strength versus increasing relative amounts of organic binder (e.g., HPMC) in the mixture The resulting curve 1830 shows increasing observed strength up to an optimal point 1840 where, thereafter, strength begins to decrease again.

While it is possible to vary the temperature of the mixture, in general an observed optimal temperature for the mixing of components is approximately 15° C.

The above-described controlling factors are variously interrelated. For example, changing the weight percentage of one component will vary the corresponding weight percentages of other components. The resulting change to the substrate from changing the parameter of each component can be tracked on the respective graph for that component. Other controlling factors are either minimally interrelated or unrelated to other factors or components—for example, particle size. The affects of varying these parameters can be tracked mainly on the associated graph.

### D. An Operative Example of Varying Controllable Factors

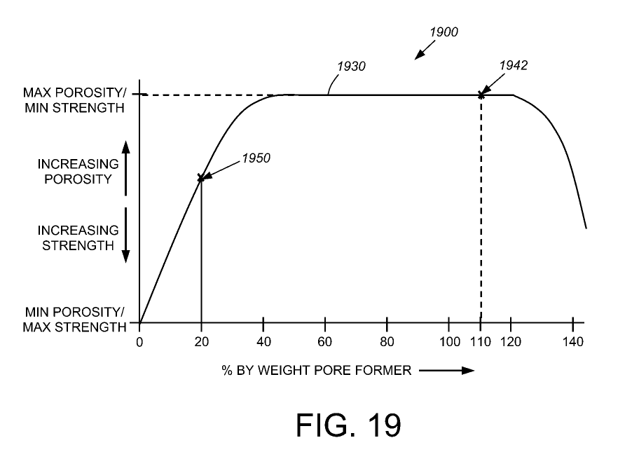

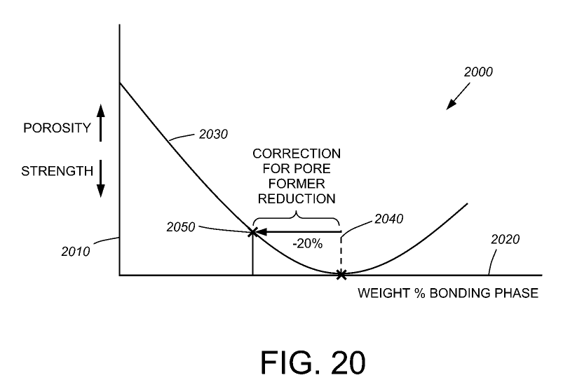

A realistic example of the use of the above-described controlling factors to optimize the mixture is described with reference to FIGS. 19 and 20. In general, a pore former weight percentage of 110% on a dry weight basis (without water in the mixture) can achieve a desired strength and porosity as indicated by graph 300 of FIG. 3. FIG. 19 reproduces that graph 1900 and the 120-percent weight of pore former is indicated on the curve 1930 by the line and curve point 1942. While this quantity of pore former is effective, it is also results in increased materials expense and a larger emission of volatile components during curing (mainly carbon dioxide, but also other volatile organic vapors including carbon monoxide). It would be desirable to lower the amount of needed pore former, while still maintaining desired strength and porosity, as lowering the amount of pore former in the mixture will save costs and reduce emissions.

As shown in FIG. 19, lowering the quantity of pore former to approximately 20% on a dry-weight basis (approximately 14% including water) normally results in a substrate with increased strength, but reduced porosity, as evidenced by the point 1950. Taken alone, porosity is reduced by approximately 15% from its desired maximum level.

However, it is recognized that a change in the weight percent of bonding phase can also affect the porosity/strength relationship. The graph 2000 of FIG. 20 reproduces the graph 1600 of FIG. 16 in which increase in weight percent of bonding phase (horizontal axis 2020) is plotted against porosity/strength (vertical axis 2010). The resulting curve 2030 has an optimal strength at the point 2040. However, by reducing the amount of bonding phase, the porosity is increased. In this example, a 20% decrease in bonding phase establishes curve point 2050 in which porosity is increased with some (acceptable) reduction in strength (with respect to that particular factor). This reduction in strength is, however at least partially compensated by the increase in strength by reducing pore former (FIG. 19). Thus a mixture using less pore former and less bonding phase is derived, which exhibits similar strength and similar porosity as a mixture having more of each compound—and significantly more pore former. Note that less bonding phase is also advantageous in that is reduces the internal insulating effect and thereby reduces risk of thermal shock where there are significant thermal gradients within the substrate during field use. One use in which there may be substantial temperature gradients in the field of vehicle emissions filtration. The reduced bonding phase component is, thus, advantageous in such applications.

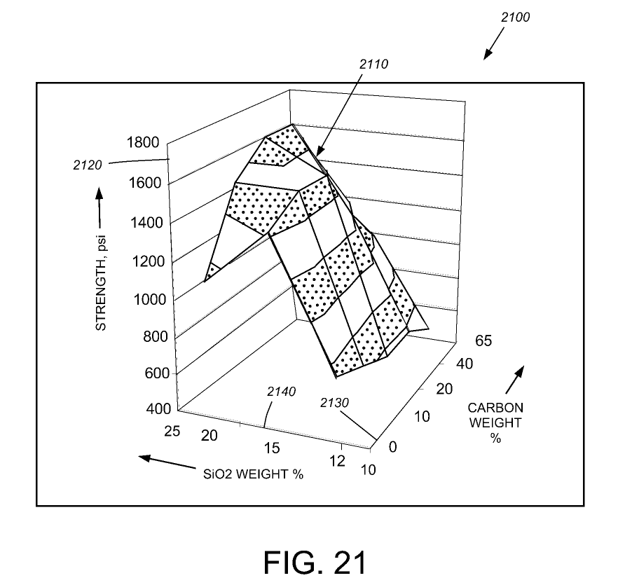

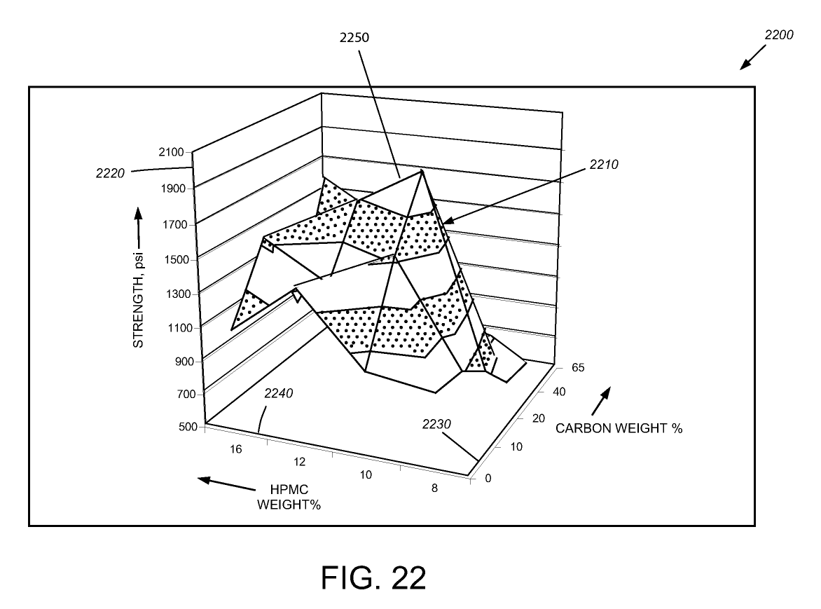

Before discussing a particular example of a substrate that can be achieved in accordance with this invention, reference is briefly made to FIGS. 21 and 22, which depict respective graphs 2100 and 2200 that show three-dimensional relationships between selected controlling factors and components. More particularly, FIG. 21 depicts a three dimensional curve 2100 of substrate strength, (vertical axis 2120) relative to both pore former (carbon) weight percentage (first horizontal axis 2130) and glass bonding phase SiO₂ weight percentage (second horizontal axis 2140) (both being dry weight basis). As depicted, the curve 2110 defines the form of a dome, with highest strength (approximately 1600 psi) achieved with a carbon weight percentage between 20% and 65% and the bonding phase percentage between approximately 20% and 25%.

Similarly, the graph 2200 of FIG. 22 depicts a three dimensional curve 2210 of substrate strength, (vertical axis 2220) relative to both pore former (carbon) weight percentage (first horizontal axis 2230) and HPMC weight percentage (second horizontal axis 2240) (both being dry weight basis). The curve 2210 also defines an irregularly shaped dome, with the highest strength (approximately 1600 psi) achieved for carbon quantities between approximately 20% and 65%, and HPMC between approximately 12% and 16%. Note that a ridge 2250 relates higher HPMC and lower pore former.

### E. Specific Example of an Illustrative Substrate and Its Performance

The following table lists the components and relative amounts thereof for a substrate initial mixture which is derived based upon an understanding and use of the above-described controlling factors:

ILLUSTRATIVE SUBSTRATE MIXTURE
(Reduced Pore Former Quantity)

| COMPONENT | MIXTURE WEIGHT % | DRY WEIGHT % |
|---|---|---|
| Bulk Mullite Fiber | 35.4% | 52.1% |
| Water | 32.1% | 0.0% |
| HPMC | 9.9% | 14.6% |
| Bentonite | 3.2% | 4.7% |
| Colloidal SiO₂ | 5.3% | 7.8% |
| Pore Former | 14.1% | 20.8% |
| Total | 100.0% | 100.0% |

The mullite fiber employed in the mixture was the above-described Unifrax Fiberfrax polycrystalline mullite fiber, in bulk or pre-chopped form. The fibers exhibited a range of diameters from approximately 3 to 8 microns with an average of 3.5 microns. The pore former is a carbon graphite particulate with a particle size between approximately 7 microns to 45 microns (−325 mesh). The components were mixed for 75 minutes and then extruded into a plurality of green substrates, which were each dried at 120° C. The dried substrates were then cured according to the procedures described above. The resulting cured/sintered substrates each exhibited an average (desirable) porosity of approximately 61% with a standard deviation of only 0.6%. The substrates also exhibited an average crush strength of approximately 1731 psi with a standard deviation of 156 psi. By way of comparison experimentation has revealed that substrates employing twice the amount of pore former (over 40% dry weight basis) exhibit less than 15% greater porosity—with almost 200 psi lower crush strength. Thus a substrate with an acceptable crush strength and desirable porosity is achieved with the use of substantially less pore former.

The following table lists the components and relative amounts thereof for a reaction-formed substrate initial mixture which is derived based upon an understanding and use of the above-described factors:

ILLUSTRATIVE SUBSTRATE MIXTURE
(Reduced Particle Size)

| COMPONENT | MIXTURE WEIGHT % | DRY WEIGHT % |
|---|---|---|
| Carbon Fiber | 16.67% | 23.26% |
| Water | 28.30% | 0.00% |
| HPMC | 11.12% | 15.50% |
| Bentonite | 5.00% | 6.98% |
| Silicon | 38.91% | 54.26% |
| Total | 100.0% | 100.0% |

The carbon fiber employed in the mixture was a Zoltek 1M17010 PAN fiber in a chopped form, having a diameter of approximately 10 microns. The silicon powder was Elkem EMI-OT-36211 10 micron mean particle size. The components were mixed for 75 minutes and then extruded into a plurality of green substrates, which were each dried at 120° C. The dried substrates were then cured according to the procedures described above for reaction-formed silicon carbide. The resulting cured/sintered substrates each exhibited an average porosity of approximately 63.8% with a standard deviation of only 0.5% and a crush strength of 1521 psi with a standard deviation of 137 psi. By way of comparison experimentation has revealed that substrates employing the same relative quantities of components with only a change being a silicon powder particle size of 45 microns exhibit porosity of 69.4% with crush strength of 930 psi. Thus a substrate with an acceptable crush strength and desirable porosity is achieved with the use of a modified bonding phase component.

It should be clear that varying other controlling factors may further affect the strength and porosity performance of the exemplary substrate. Further modifications to the mixture are expressly contemplated. For the purposes of an illustrative embodiment of a substrate, each of the weight percentages (on dry weight basis) can be contemplated to deviate by at least approximately ±5 percent and still achieve an acceptably performing material. However, wider ranges of variation in particular controllable factors are also contemplated. For example, use of a pore former in a range of approximately 5% to 45% (dry weight basis) is contemplated in an illustrative embodiment. Likewise use of a bonding phase (combined bentonite, glass and additives) in a range of approximately 2 to 33 percent is contemplated. In this example, the mullite is provided in a range of approximately 45 and 55 percent, while the HPMC is provided in a range of approximately 2-20 percent.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, where other additives and components are provided to the mixture, associated graphs for such components and their controlling/controllable factors can be derived relative to porosity/strength of the cured/sintered substrate. In addition, further modifications to the curing, drying and/or organic removal steps may be implemented in conjunction with adjustments to the mixture components contemplated herein. Also while the variation of controllable factors is represented by a series of respective curves, the term “curve” should be taken broadly to include any map, equation or table of performance data that exhibits variation in the performance in response to variation in the controllable factor of the component. Accordingly, this description is meant to be taken only by way of example, and not to otherwise limit the scope of this invention.

What is claimed is:

1. A method for fabricating a ceramic substrate comprising the steps of:
providing a plurality of components, including a ceramic fiber and a bonding phase to an initial mixture in solution with a fluid solvent including at least a first component and a second component;
identifying at least one controllable factor respectively associated with each of the components and determining a respective curve of strength and porosity in a cured substrate achieved by varying each controllable factor;
varying the controllable factor of the first component based upon the respective curve for the controllable factor of the first component; and
to compensate for a change in strength and porosity by varying the controllable factor of the first component, varying the controllable factor of the second component based upon the curve for the controllable factor of the second component.

2. The method as set forth in claim 1 further comprising:
identifying at least one controllable factor respectively associated with a third component of the plurality of components and determining a curve of strength and porosity in a cured substrate achieved by varying the controllable factor of the third component, and
to compensate for a change in strength and porosity by varying the controllable factor of at least one of the first component and the second components, varying the controllable factor of the third component based upon the curve for the controllable factor of the third component.

3. The method as set forth in claim 1 wherein the first component is pore former and the controllable factor thereof is mixture weight percentage of pore former.

4. The method as set forth in claim 3 wherein the second component is bonding phase and the controllable factor thereof is mixture weight percentage of bonding phase.

5. The method as set forth in claim 4 wherein the step of varying the first component includes reducing the mixture weight percentage of pore former to thereby map to a lower porosity and higher strength on the respective curve and the step of varying the second component includes reducing the mixture weight percentage of bonding phase in response to reducing the pore former to thereby map to a higher porosity and lower strength on the respective curve that at least partially compensates for the lower porosity and higher strength by reducing the mixture weight percentage of pore former.

6. The method as set forth in claim 1 wherein the first component is one of pore former, ceramic fiber, bonding phase and organic binder and the second component is another one of pore former, ceramic fiber, bonding phase and organic binder.

7. The method as set forth in claim 6 wherein (a) a controllable factor of the pore former is at least one of (i) mixture weight percentage of pore former, (ii) particle density of pore former and (iii) particle size of pore former, (b) a controllable factor of the ceramic fiber is at least one of (i) mixture weight percentage of ceramic fiber, (ii) fiber diameter of ceramic fiber and (iii) fiber diameter uniformity of ceramic fiber, (c) a controllable factor of the bonding phase is at least one of (i) mixture weight percentage of bonding phase and (ii) viscosity of the bonding phase at a sintering temperature, and (d) a controllable factor of the organic binder is at least one of (i) mixture weight percentage of organic binder and (ii) mixture solvent content.

8. The method as set forth in claim 7 wherein the particle size of the pore former is an optimum at an intermediate particle size in a range of between approximately 7 microns and 45 microns.

9. The method as set forth in claim 7 wherein the step of varying the first component includes reducing the mixture weight percentage of pore former to thereby map to a lower porosity and higher strength on the respective curve and the step of varying the second component includes reducing the mixture weight percentage of bonding phase in response to reducing the pore former to thereby map to a higher porosity and lower strength on the respective curve that at least partially compensates for the lower porosity and higher strength by reducing the mixture weight percentage of pore former.

10. A porous ceramic substrate constructed in accordance with the method of claim 9.

11. A porous ceramic substrate constructed in accordance with the method of claim 1.

12. The method as set forth in claim 1 wherein the ceramic fiber comprises a mullite fiber and the bonding phase comprises a glass bonding phase.

13. The method as set forth in claim 1 wherein the ceramic fiber comprises an aluminosilicate fiber and the bonding phase comprises at least one of a glass and a glass-ceramic.

14. A system for fabricating a ceramic substrate comprising:
a plurality of components, including a ceramic fiber and a bonding phase, to an initial mixture in solution with a fluid solvent including at least a first component and a second component;
at least one controllable factor respectively associated with each of the components and each controllable factor defining a respective curve of strength and porosity in a cured substrate achieved by varying each controllable factor;
a first varying process that varies the controllable factor of the first component based upon the respective curve for the controllable factor of the first component; and
a second varying process, compensating for a change in strength and porosity by varying the controllable factor of the first component, that varies the controllable factor of the second component based upon the curve for the controllable factor of the second component.

15. A method for fabricating a porous substrate comprising the steps of:
defining curves that represent strength and porosity of a cured version of the substrate for at least one controllable factor related to each of a plurality of respective components of an initial mixture that, in a fluid solvent, is used to construct a green extruded substrate, the plurality of components including fibers and a bonding phase; and
adjusting the controllable factor of at least a first of the plurality of components based upon a respective one of the curves so as to vary the strength and porosity of the cured substrate.

16. The method as set forth in claim 15 further comprising adjusting the controllable factor of at least a second of the plurality of components based upon a respective one of the curves to compensate for a variation in the strength and porosity of the cured substrate caused by the adjusting of the controllable factor of the first of the plurality of components.

17. The method as set forth in claim 15 wherein the fiber is a carbon fiber and the bonding phase is silicon.

18. The method as set forth in claim 15 wherein the fiber is an aluminosilicate fiber and the bonding phase is at least one of a glass and a glass-ceramic.

19. The method as set forth in claim 15 wherein the controllable factor of the first of the plurality of components is at least one of mixture weight percentage of pore former, particle density of pore former, particle size of pore former, mixture weight percentage of fiber, fiber diameter, fiber diameter uniformity, mixture weight percentage of bonding phase, viscosity of the bonding phase at a sintering temperature, mixture weight percentage of organic binder, and mixture solvent content.

20. The method as set forth in claim 15 further comprising the step of a reaction of the plurality of components to form a composition of the cured substrate that is different than the composition of the fibers.
